(19) United States
(12) Patent Application Publication
(10) Pub. No.: US 2026/0225189 A1
(43) Pub. Date: Aug. 6, 2026

(54) LASER PROCESSING METHOD AND LASER PROCESSING APPARATUS

(71) Applicant: Gigaphoton Inc., Tochigi (JP)

(72) Inventor: Takashi ONOSE, Tochigi (JP)

(73) Assignee: Gigaphoton Inc., Tochigi (JP)

(21) Appl. No.: 19/439,275

(22) Filed: Jan. 2, 2026

(30) Foreign Application Priority Data
Feb. 3, 2025 (JP) 2025-016107

(51) Int. Cl. B23K 26/382; B23K 26/064; B23K 26/082; B23K 26/10; B23K 26/12; B23K 26/16; B23K 103/00

(52) U.S. Cl. CPC B23K 26/382; B23K 26/0648; B23K 26/082; B23K 26/10; B23K 26/128; B23K 26/16; B23K 2103/42

(57) ABSTRACT

A laser processing method includes a first step of processing a pilot hole by irradiating fluororesin with a pulse laser beam having an ultraviolet wavelength so as to draw a first closed trajectory, and a second step of processing a hole by irradiating the fluororesin in which the pilot hole is processed with the pulse laser beam so as to draw a second closed trajectory that is similar in shape to the first closed trajectory and is larger than the first closed trajectory.

### CROSS-REFERENCE TO RELATED APPLICATIONS

The present application claims the benefit of Japanese Patent Application No. 2025-016107, filed on Feb. 3, 2025, the entire contents of which are hereby incorporated by reference.

### BACKGROUND

### 1. Technical Field

The present disclosure relates to a laser processing method and a laser processing apparatus.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

In addition, excimer laser beams are sometimes used for direct processing of a polymer material and a glass material or the like, since a pulse width is about several tens of ns and a wavelength is as short as about 248 nm and about 193 nm, respectively. A chemical bond in a polymer material can be cut by an excimer laser beam having photon energy higher than bond energy. Therefore, it is known that non-heating processing of a polymer material is made possible by an excimer laser beam, and a processing shape becomes smooth. Further, since glass, ceramics, and the like have a high absorptance to an excimer laser beam, it is known that even a material that is difficult to be processed by visible and infrared laser beams can be processed by an excimer laser beam.

### LIST OF DOCUMENTS

### Patent Documents

Patent Document 1: International Publication No. WO1990-001374

Patent Document 2: Japanese Unexamined Patent Application Publication No. 2007-237235

### SUMMARY

A laser processing method according to one aspect of the present disclosure includes a first step and a second step. The first step is configured to process a pilot hole by irradiating fluororesin with a pulse laser beam having an ultraviolet wavelength so as to draw a first closed trajectory. The second step is configured to process a hole by irradiating the fluororesin in which the pilot hole is processed with the pulse laser beam so as to draw a second closed trajectory that is similar in shape to the first closed trajectory and is larger than the first closed trajectory.

A laser processing apparatus according to another aspect of the present disclosure includes a light condensing lens, a moving device, and a processor. The light condensing lens is configured to condense a pulse laser beam having an ultraviolet wavelength onto fluororesin that is a workpiece. The moving device is configured to move an irradiation position of the pulse laser beam on the fluororesin. The processor is configured to control the moving device. The processor executes first control for processing a pilot hole by irradiating the fluororesin with the pulse laser beam so as to draw a first closed trajectory, and second control for processing a hole by irradiating the fluororesin in which the pilot hole is processed with the pulse laser beam so as to draw a second closed trajectory that is similar in shape to the first closed trajectory and is larger than the first closed trajectory.

### BRIEF DESCRIPTION OF THE DRAWINGS

Some embodiments of the present disclosure will be described below, by way of example only, with reference to the accompanying drawings.

FIG. 1 is a diagram schematically illustrating a configuration of a laser processing system according to a comparative example.

FIG. 2 is a diagram illustrating an example of a closed trajectory of a pulse laser beam on a surface of a workpiece by a laser processing method according to the comparative example.

FIG. 3 is an explanatory diagram schematically illustrating a state of scattered light and heat generated when performing hole processing on a workpiece by irradiation with a pulse laser beam on a closed trajectory.

FIG. 4 is a diagram schematically illustrating a cross section of a hole processed by the laser processing method according to the comparative example.

FIG. 5 is a diagram schematically illustrating a configuration of a laser processing system including a laser processing apparatus according to Embodiment 1.

FIG. 6 is a top view of a dust collecting head.

FIG. 7 is a diagram illustrating an example of a trajectory of a pulse laser beam on a surface of a workpiece by a laser processing method according to Embodiment 1.

FIG. 8 is a sectional view illustrating an example of a pilot hole obtained by a first step.

FIG. 9 is a sectional view illustrating an example of a hole obtained by a second step.

### DESCRIPTION OF EMBODIMENTS

### Contents

1 Overview of Laser Processing System according to Comparative Example
   1.1 Configuration
   1.2 Operation
   1.3 Problem
2. Embodiment 1
   2.1 Configuration
   2.2 Operation
   2.3 Effect and Advantage
   2.4 Specific Example of Hole Processing
   2.5 About Processing Conditions
   2.6 Example of Applications of Workpiece in which Hole is Processed
3. Others

Hereinafter, an embodiment of the present disclosure will be described in detail with reference to the drawings. The embodiment described below show some examples of the present disclosure and do not limit contents of the present disclosure. In addition, all configurations and operations described in the embodiment are not necessarily essential as configurations and operations of the present disclosure. Here, the same components are denoted by the same reference signs, and any redundant description thereof is omitted.

### 1 Overview of Laser Processing System according to Comparative Example

### 1.1 Configuration

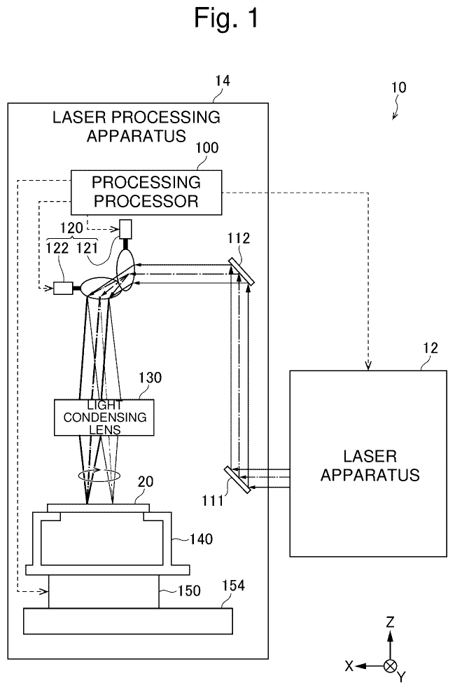

FIG. 1 is a diagram schematically illustrating a configuration of a laser processing system 10 according to a comparative example. The comparative example of the present disclosure is a form inferred from general technology by the applicant and is not a publicly known example admitted by the applicant.

The laser processing system 10 includes a laser apparatus 12 and a laser processing apparatus 14. The laser apparatus 12 outputs a pulse laser beam having an ultraviolet wavelength. For example, the laser apparatus 12 may be an excimer laser apparatus. A wavelength of the pulse laser beam output by the laser apparatus 12 may be, for example, between 158 nm and 246 nm. Note that a fluorine excimer laser apparatus can output a pulse laser beam having a wavelength of 158 nm.

The laser processing apparatus 14 includes a processing processor 100, high reflective mirrors 111 and 112, a galvano scanner 120, a light condensing lens 130, a table 140, an XYZ stage 150, and a frame 154.

The high reflective mirror 111 is arranged so as to reflect the pulse laser beam output from the laser apparatus 12 to be incident on the high reflective mirror 112. The high reflective mirror 112 is arranged so as to reflect the pulse laser beam reflected by the high reflective mirror 111 towards the galvano scanner 120.

The galvano scanner 120 includes an X-direction galvano scanner 121 that scans the pulse laser beam in an X direction and a Y-direction galvano scanner 122 that scans the pulse laser beam in a Y direction. Operations of the X-direction galvano scanner 121 and the Y-direction galvano scanner 122 are controlled in synchronization with a timing at which the laser apparatus 12 outputs the pulse laser beam. In FIG. 1, a direction parallel to a direction in which the pulse laser beam travels from the light condensing lens 130 to a workpiece 20 is defined as a Z direction. The X direction and the Y direction are orthogonal to the Z direction and are also orthogonal to each other. In subsequent drawings, coordinate axes are same as those in FIG. 1.

The light condensing lens 130 condenses the pulse laser beam output from the galvano scanner 120. The light condensing lens 130 may be a spherical lens, an aspherical lens, or an F-θ lens. A spot size of a focal point may be approximately 200 μm to 300 μm, for example.

The XYZ stage 150 is a stage with an actuator movable in three orthogonal axial directions that are the X direction, the Y direction, and the Z direction. The XYZ stage 150 is fixed to the frame 154, and the table 140 is placed on the XYZ stage 150. The table 140 is a mounting base for mounting the workpiece 20.

The workpiece 20 is set at a position (focus position) where the pulse laser beam is condensed by the light condensing lens 130 on the table 140. The workpiece 20 is made of fluororesin, for example, polytetrafluoroethylene (PTFE). The workpiece 20 may be made of materials other than the PTFE, such as perfluoroalkoxy alkanes (PFA), perfluoroethylene propylene copolymers (FEP), or polyvinylidene fluoride (PVDF).

The processing processor 100 controls the operation of the laser apparatus 12, the galvano scanner 120, and the XYZ stage 150. The processing processor 100 may be physically configured as hardware to execute various kinds of processing included in the present disclosure. For example, the processing processor 100 may be a computer including a memory that stores a control program defining the various kinds of processing and a processing device that executes the control program. The control program may be stored in one memory, or may be stored separately in a plurality of memories at physically separate locations, and the various kinds of processing may be defined by a combination of control programs stored in the memories. The processing device may be a general-purpose processing device such as a CPU (Central Processing Unit), or a special-purpose processing device such as a GPU (Graphics Processing Unit).

Alternatively, the processing processor 100 may be programmed as software to execute the various kinds of processing included in the present disclosure. For example, the processing processor 100 may be implemented as a dedicated device such as an ASIC (Application Specific Integrated Circuit) or a programmable device such as a FPGA (Field Programmable Gate Array), which has functions to execute the various kinds of processing.

The various kinds of processing included in the present disclosure may be executed by one computer, one dedicated device, or one programmable device, or may be executed by cooperation of a plurality of computers, a plurality of dedicated devices, or a plurality of programmable devices at physically separate locations. The various kinds of processing may be executed by a combination including at least any two of: one or more computers, one or more dedicated devices, and one or more programmable devices.

### 1.2 Operation

The pulse laser beam output from the laser apparatus 12 is reflected by the high reflective mirrors 111 and 112 and enters the galvano scanner 120. The processing processor 100 moves the workpiece 20 using the XYZ stage 150 so that a position of a processing point on the workpiece 20 becomes the focus position. The focus position of the light condensing lens 130 is near a surface of the workpiece 20. The light condensing lens 130 selects a focal length such that a Rayleigh length of the focal point is between 1/10 and 10 times a thickness of the workpiece 20.

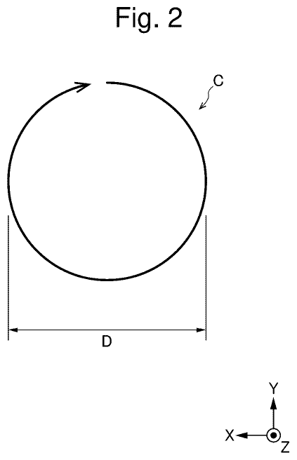

When performing hole processing on the workpiece 20, the processing processor 100 commands the galvano scanner 120 such that the pulse laser beam draws a closed trajectory at a predetermined scan speed on the surface of the workpiece 20. The closed trajectory may be a circular trajectory, for example, as illustrated in FIG. 2, or it may be an elliptical trajectory or a long elliptical trajectory for which arcs and straight lines are combined.

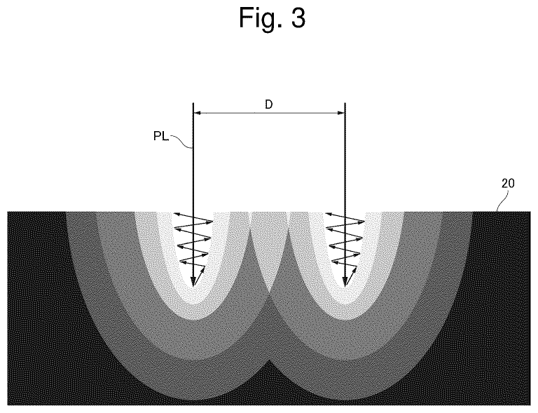

FIG. 2 is a diagram illustrating an example of a closed trajectory C of the pulse laser beam on the surface of the workpiece 20 by a laser processing method according to the comparative example. The closed trajectory C illustrated in FIG. 2 is a circular trajectory with a diameter D. FIG. 3 is an explanatory diagram schematically illustrating a state of scattered light and heat generated when performing the hole processing on the workpiece 20 by irradiation with the pulse laser beam on the closed trajectory C.

The galvano scanner 120 receives a command from the processing processor 100 and controls the X-direction galvano scanner 121 and the Y-direction galvano scanner 122 so that the pulse laser beam draws a circular trajectory at the predetermined scan speed on the surface of the workpiece 20.

The processing processor 100 outputs a control signal that turns output of the pulse laser beam on and off in accordance with the operation of the galvano scanner 120 to the laser apparatus 12. The laser apparatus 12 outputs the pulse laser beam of predetermined power in accordance with the control signal. As a result, the workpiece 20 is irradiated with the pulse laser beam and the hole processing is performed. The processing processor 100 controls the galvano scanner 120 and the laser apparatus 12 so that the pulse laser beam circulates on the closed trajectory C multiple times. Note that the pulse laser beam of about 40 pulses may be radiated per one round on the closed trajectory C. After the hole processing is completed, the processing processor 100 moves the workpiece 20 using the XYZ stage 150 so that an irradiation position of the pulse laser beam becomes the position of the next processing point.

### 1.3 Problem

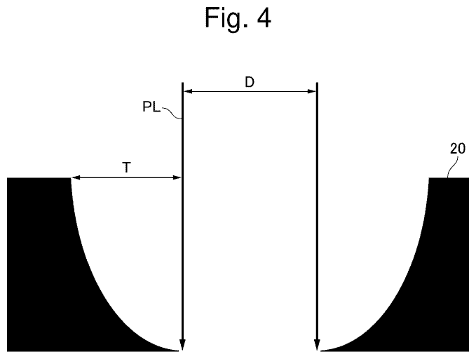

FIG. 4 is a diagram schematically illustrating a cross section of a hole processed by the laser processing method according to the comparative example. The scattered light and the heat generated by the pulse laser beam with which the workpiece 20 is irradiated process the workpiece 20 near an irradiation part. As a result, when the hole processing is performed on the closed trajectory C as illustrated in FIG. 4, a diameter of the hole on a side (the surface) where the pulse laser beam is incident is larger than the diameter of the hole on an opposite side (a back surface). In other words, the processed hole is tapered such that a processing diameter on the side where the pulse laser beam is incident is large and a processing diameter on the opposite side is small.

For example, when the hole processing is performed on 2-mm thick PTFE as the workpiece 20, where input power is 8 W, a scan speed is 200 mm/sec, a diameter D of the circular trajectory is φ0.8 mm, and a circular trajectory circulation number is 500, the diameter of the hole on the surface side of the workpiece 20 becomes φ1.6 mm and the diameter of the hole on the back surface side becomes φ0.8 mm. The input power refers to the power of the pulse laser beam with which the workpiece 20 is irradiated.

In this case, for the processed hole, an area where the hole diameter changes in a thickness direction of the workpiece 20 from an edge of the hole on the surface side to an edge of the hole on the back surface side of the workpiece 20 is a tapered area T. The larger a difference between the hole diameter on the surface side and the hole diameter on the back surface side of the workpiece 20 in the processed hole, the larger the tapered area T becomes.

In the hole processing of the fluororesin represented by the PTFE, it is demanded to process a hole with a small tapered area T.

### 2. Embodiment 1

### 2.1 Configuration

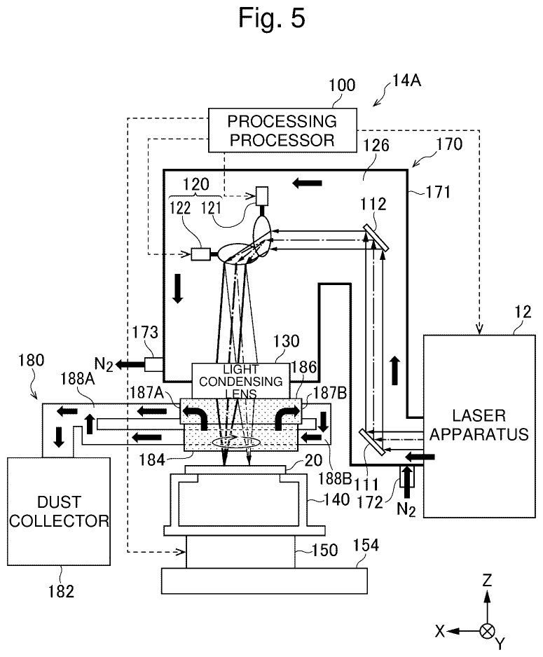

FIG. 5 is a diagram schematically illustrating a configuration of a laser processing system including a laser processing apparatus 14A according to Embodiment 1. The configuration illustrated in FIG. 5 will be described in terms of differences from that in FIG. 1. The laser processing apparatus 14A according to Embodiment 1 is provided with a purging mechanism 170 for purging an optical propagation part 126 including the high reflective mirrors 111 and 112 and the galvano scanner 120 with an inert gas, and a dust collecting mechanism 180 for protecting the light condensing lens 130. The high reflective mirrors 111 and 112 and the galvano scanner 120 are examples of an “optical system” in the present disclosure.

For the inert gas of the purging mechanism 170, a nitrogen (N₂) gas may be used. For the N₂ gas used for purging, the N₂ gas supplied from a pulse laser beam output part of the laser apparatus 12 may be used, the N₂ gas may be introduced from outside the laser processing apparatus 14A, or both may be used. A non-illustrated lens arranged in the pulse laser beam output part may be used as a sealing part of a purged area.

The purging mechanism 170 illustrated in FIG. 5 includes a gas inlet 172 for introducing the N₂ gas from the outside into a housing 171 that covers the area of the optical propagation part 126, and a gas outlet 173 for discharging the N₂ gas from inside the housing 171. The gas inlet 172 is provided near the pulse laser beam output part of the laser apparatus 12, and the gas outlet 173 is provided near the light condensing lens 130. The N₂ gas supplied into the housing 171 from at least one of the pulse laser beam output part of the laser apparatus 12 and the gas inlet 172 flows to the high reflective mirrors 111 and 112, the galvano scanner 120, and the light condensing lens 130 and is discharged from the gas outlet 173.

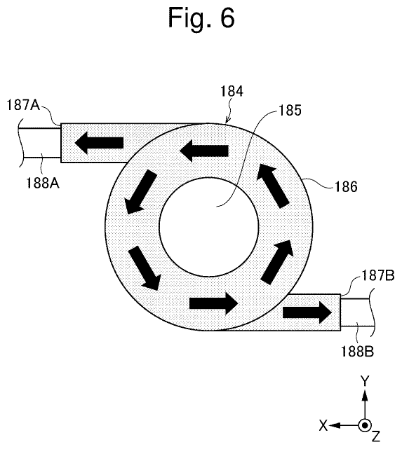

The dust collecting mechanism 180 includes a dust collector 182 and a dust collecting head 184. FIG. 6 is a top view of the dust collecting head 184. The dust collecting head 184 has a space 185 at a center that allows light to be introduced, and two or more suction ports 187A and 187B are provided on an annular cover 186 that forms an air passage annularly surrounding the space 185 that is the light introduction part. Each of the suction ports 187A and 187B is connected to the dust collector 182 via pipes 188A and 188B.

The dust collecting head 184 can generate a spiral airflow by sucking air through the suction ports 187A and 187B. The airflow generated in this way moves plumes and dust generated during the processing to an outer peripheral part, thereby suppressing the plumes and the dust from blocking the pulse laser beam and reducing processing efficiency, as well as suppressing the plumes and the dust from adhering to the light condensing lens 130 and causing damage of the lens and reduction of a transmittance.

Further, ozone generated by incidence of the pulse laser beam is also moved to an outer periphery from the irradiation part of the pulse laser beam by the generated airflow, allowing efficient processing in an atmospheric environment without the pulse laser beam being absorbed by the ozone. Other configurations are the same as those of the laser processing system 10.

### 2.2 Operation

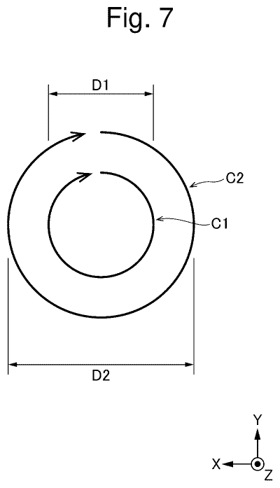

FIG. 7 is a diagram illustrating an example of a trajectory of the pulse laser beam on the surface of the workpiece 20 by the laser processing method according to Embodiment 1. The laser processing method when performing the hole processing on the workpiece 20 using the laser processing apparatus 14A according to Embodiment 1 includes a step of processing a pilot hole by irradiating the workpiece 20 with the pulse laser beam so as to draw a first closed trajectory C1, and a step of processing a hole by irradiating the workpiece 20 in which the pilot hole is processed with the pulse laser beam so as to draw a second closed trajectory C2 that is similar in shape to the first closed trajectory C1 and is larger than the first closed trajectory C1. The second closed trajectory C2 may coincide with a shape of the hole to be a processing target (object). “Coincidence” includes not only perfect coincidence but also a concept of approximate coincidence within a practically allowable range.

The step of processing a pilot hole is an example of a “first step” in the present disclosure, and the step of processing a hole that is closer in a processing shape to the hole to be the processing target (object) than the pilot hole after processing the pilot hole is an example of a “second step” in the present disclosure. In addition, control for processing a pilot hole is an example of “first control” in the present disclosure, and control for processing a hole that is closer in the processing shape to the hole to be the processing target than the pilot hole after processing the pilot hole is an example of “second control” in the present disclosure. The laser processing method according to Embodiment 1, which includes the first and second steps, is carried out in the atmospheric environment without using an assist gas.

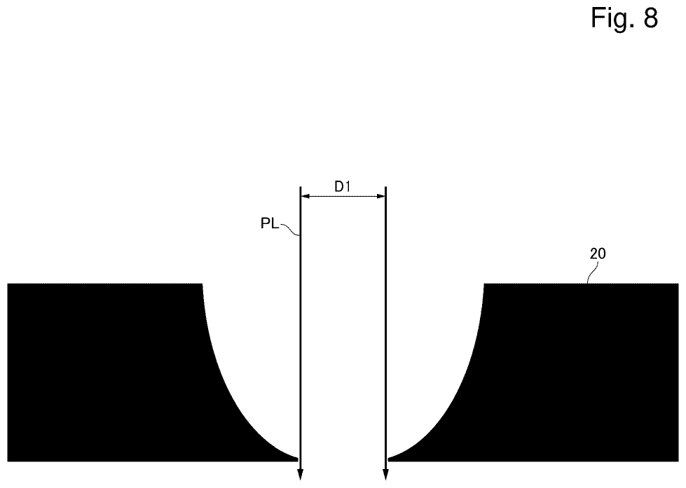

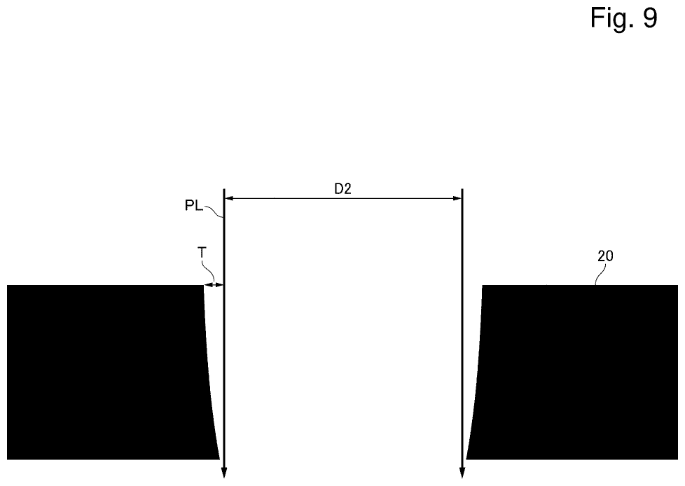

FIG. 8 is a sectional view illustrating an example of a pilot hole obtained by the first step. FIG. 9 is a sectional view illustrating an example of a hole obtained by the second step.

When performing the hole processing on the workpiece 20 using the laser processing apparatus 14A according to Embodiment 1, the processing processor 100 commands the galvano scanner 120 such that the pulse laser beam draws the first closed trajectory C1 at the predetermined scan speed on the surface of the workpiece 20. The first closed trajectory C1 may be a circular trajectory, for example, as illustrated in FIG. 7, or it may be an elliptical trajectory or a long elliptical trajectory.

The galvano scanner 120 receives a command from the processing processor 100 and controls the X-direction galvano scanner 121 and the Y-direction galvano scanner 122 so that the pulse laser beam draws the first closed trajectory C1 at the predetermined scan speed on the surface of the workpiece 20.

The processing processor 100 outputs the control signal that turns the output of the pulse laser beam on and off in accordance with the operation of the galvano scanner 120 to the laser apparatus 12. The laser apparatus 12 outputs the pulse laser beam of the predetermined power in accordance with the control signal. As a result, a pilot hole is processed in the workpiece 20 (see FIG. 8). The pilot hole does not have to pass through, but it is preferable that it passes through. A through pilot hole is an example of a “through-hole” in the present disclosure.

Subsequently, the processing processor 100 commands the galvano scanner 120 such that the pulse laser beam draws the second closed trajectory C2 that is similar in shape to the first closed trajectory C1 and is larger than the first closed trajectory C1 at the predetermined scan speed on the surface of the workpiece 20, as illustrated in FIG. 7. The second closed trajectory C2 may be a circular trajectory, an elliptical trajectory, or a long elliptical trajectory.

When the first closed trajectory C1 is a circular trajectory with a diameter D1, the second closed trajectory C2 is a circular trajectory with a diameter D2, and the diameter D2 is larger than the diameter D1 (D1<D2). It is preferable that a center of the first closed trajectory C1 and a center of the second closed trajectory C2 coincide. FIG. 7 illustrates an example where the first closed trajectory C1 and the second closed trajectory C2 are concentric circles. Note that a center of a closed trajectory other than a circular trajectory may be, for example, a centroid of a figure whose contour line is the closed trajectory. It is preferable that a distance between the first closed trajectory C1 and the second closed trajectory C2 is constant over an entire circumference of the closed trajectory.

In addition, the second closed trajectory C2 is drawn inside an area where the thickness of the workpiece 20 is changed since the pilot hole is processed on the first closed trajectory C1. That is, the area surrounded by the second closed trajectory C2 is smaller than the area where the thickness of the workpiece 20 is changed since the processing is performed on the first closed trajectory C1, and is included in the area where the thickness of the workpiece 20 is changed due to the first step.

The galvano scanner 120 receives a command from the processing processor 100 and controls the X-direction galvano scanner 121 and the Y-direction galvano scanner 122 so that the pulse laser beam draws the second closed trajectory C2 at the predetermined scan speed on the surface of the workpiece 20.

The processing processor 100 outputs the control signal that turns the output of the pulse laser beam on and off in accordance with the operation of the galvano scanner 120 to the laser apparatus 12. The laser apparatus 12 outputs the pulse laser beam of the predetermined power in accordance with the control signal. As a result, the hole processing is performed.

When the hole processing is completed, the processing processor 100 moves the workpiece 20 using the XYZ stage 150 so that the irradiation position of the pulse laser beam becomes the position of the next processing point. The processing processor 100 is an example of a “processor” in the present disclosure. The galvano scanner 120 and the XYZ stage 150 are examples of a “moving device” in the present disclosure.

In addition, in the laser processing apparatus 14A according to Embodiment 1, processing of reducing the thickness may be performed on an area smaller than the area where the thickness of the workpiece 20 is changed due to laser irradiation on the second closed trajectory C2 before performing processing by the laser irradiation on the second closed trajectory C2.

That is, between the step of processing a pilot hole on the first closed trajectory C1 and the step of processing a hole in a target processing shape on the second closed trajectory C2 after processing the pilot hole, a step of further reducing the thickness of the area where the thickness is changed during the pilot hole processing (the first process) by radiating the pulse laser beam on a third closed trajectory may be added. In this case, the third closed trajectory may be larger than the first closed trajectory C1 and smaller than the second closed trajectory C2. Similarly, between the step of reducing the thickness by radiating the pulse laser beam on the third closed trajectory and the step of processing a target hole on the second closed trajectory C2, a step of further reducing the thickness of the area where the thickness is changed due to the laser irradiation on the first closed trajectory C1 and the third closed trajectory by radiating the pulse laser beam on a fourth closed trajectory may be added. In this case, the fourth closed trajectory may be larger than the third closed trajectory and smaller than the second closed trajectory C2. In this way, in the laser processing method according to Embodiment 1, a pilot hole may be processed while gradually changing a size of the closed trajectory, and a hole in the target processing shape may be ultimately processed.

### 2.3 Effect and Advantage

When processing a pilot hole in advance on the first closed trajectory C1 by the laser processing method according to Embodiment 1, the hole processing by the second closed trajectory C2 starts from a state where part of the workpiece 20 has been processed. Therefore, processing time is shorter compared to a case where the processing is performed on the second closed trajectory C2 from the beginning.

In addition, when a pilot hole is processed in advance, a space for a pilot hole area is formed in the workpiece 20. Therefore, the scattered light generated during the hole processing on the second closed trajectory C2 hits an inner surface of the hole fewer times compared to the case where the processing is performed on the second closed trajectory C2 from the beginning.

These effects suppress a temperature rise at a location where the hole is processed. Further, an amount processed by the scattered light is also suppressed. As a result, it is possible to process a hole with a small tapered area T.

### 2.4 Specific Example of Hole Processing

For example, when performing the pilot hole processing on the 2-mm thick PTFE where the input power is 8 W, the scan speed is 400 mm/sec, the circular trajectory has the diameter D1 of φ0.4 mm as the first closed trajectory C1, and the circulation number is 800 and then performing the hole processing where the input power is 8 W, the scan speed is 400 mm/sec, the circular trajectory has the diameter D2 of φ0.8 mm as the second closed trajectory C2, and the circulation number is 500, the hole with the diameter on the surface on a side of the PTFE irradiated with the pulse laser beam being φ1.2 mm and the diameter on the back surface being φ0.8 mm can be processed.

While the hole processed by the laser processing method according to the comparative example has a diameter of φ1.6 mm on the side irradiated with the pulse laser beam, it becomes as small as φ1.2 mm in the laser processing method according to Embodiment 1. Therefore, in Embodiment 1, it is possible to perform laser processing of a hole with a small tapered area T in the hole processing of the PTFE by irradiation with the pulse laser beam having the ultraviolet wavelength.

Further, in the specific example above, in the laser processing method according to Embodiment 1, the scan speed is increased compared to that in the laser processing method according to the comparative example, and the processing is performed at the scan speed (400 mm/sec) that is twice the scan speed (200 mm/sec) in the comparative example. Therefore, the processing time by the laser processing method according to Embodiment 1 can be approximately equal to or shorter than the processing time by the laser processing method according to the comparative example.

In addition, in the laser processing apparatus 14A according to Embodiment 1, since the workpiece 20 is irradiated with the pulse laser beam from one direction, the processing of a pilot hole and the processing of a hole thereafter are continuously performed, and the next hole is processed after one hole is processed, the processing time can be shortened without need of inverting the surface of the workpiece 20.

Further, since the laser processing method according to Embodiment 1 can shorten the processing time, it has an effect of suppressing thermal effects generated during the processing of the PTFE, that is the workpiece 20.

### 2.5 About Processing Conditions

### [1] Scan Speed

Conditions for the scan speed of drawing the first closed trajectory C1 and the scan speed of drawing the second closed trajectory C2 may be appropriately determined based on the thickness of the workpiece 20, the power of the pulse laser beam, the target hole processing shape, an allowable size of the tapered area T, and the like. The scan speed of drawing the first closed trajectory C1 and the scan speed of drawing the second closed trajectory C2 may be equal or may be different. For the first closed trajectory C1, the conditions that the scan speed is 400 mm/sec and the circulation number is 800 are examples of conditions experimentally determined to be suitable for processing a through-hole as a pilot hole. In addition, for the second closed trajectory C2, the conditions that the scan speed is 400 mm/sec and the circulation number is 500 are examples of conditions experimentally determined to be suitable for processing a target hole.

### [2] Circulation Number of Closed Trajectory

The number of times of circulating on the first closed trajectory C1 when processing a pilot hole and the number of times of circulating on the second closed trajectory C2 after processing the pilot hole may be also appropriately determined based on the thickness of the workpiece 20, the power of the pulse laser beam, the target hole processing shape, the allowable size of the tapered area T, and the like.

The circulation number of the first closed trajectory C1 and the circulation number of the second closed trajectory C2 may each be multiple. For example, the number of times of circulating on the second closed trajectory C2 may be smaller than the number of times of circulating on the first closed trajectory C1.

### 2.6 Example of Applications of Workpiece in which Hole is Processed

The workpiece 20 in which the hole is processed may be used, for example, for a braille device. The braille device requires about 100 densely packed holes on a PTFE sheet having area of about 50 cm², for example. By using the laser processing apparatus 14A according to Embodiment 1, a plurality of holes can be processed in the PTFE sheet. By the laser processing method according to Embodiment 1, it is possible to process the holes that are spaced apart from each other by a distance of, for example, more than 0.1 mm and less than 3.0 mm.

### 3. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C. In addition, it should be interpreted to also include combinations of any thereof and any other than A, B, and C.

What is claimed is:

1. A laser processing method comprising:
a first step of processing a pilot hole by irradiating fluororesin with a pulse laser beam having an ultraviolet wavelength so as to draw a first closed trajectory; and
a second step of processing a hole by irradiating the fluororesin in which the pilot hole is processed with the pulse laser beam so as to draw a second closed trajectory that is similar in shape to the first closed trajectory and is larger than the first closed trajectory.

2. The laser processing method according to claim 1, wherein
the second closed trajectory is included in an area where a thickness of the fluororesin is changed due to the first step.

3. The laser processing method according to claim 1, wherein
the ultraviolet wavelength is between 158 nm and 246 nm.

4. The laser processing method according to claim 1, wherein
the pilot hole is a through-hole.

5. The laser processing method according to claim 1, wherein
the first closed trajectory is a circular trajectory.

6. The laser processing method according to claim 1, wherein
the first step and the second step are performed in an atmospheric environment without using an assist gas.

7. The laser processing method according to claim 1, wherein
the second closed trajectory coincides with a shape of a hole as a processing target.

8. The laser processing method according to claim 1, wherein
the hole is processed by irradiating an inner side of an area where a thickness of the fluororesin is changed due to the first process, with the pulse laser beam, so as to draw the second closed trajectory.

9. The laser processing method according to claim 1, wherein
a center of the first closed trajectory and a center of the second closed trajectory coincide.

10. The laser processing method according to claim 1, wherein
the first step includes irradiating the fluororesin with the pulse laser beam so as to draw the first closed trajectory multiple times, and
the second step includes irradiating the fluororesin with the pulse laser beam so as to draw the second closed trajectory multiple times.

11. The laser processing method according to claim 10, wherein
the number of times of circulating on the second closed trajectory is smaller than the number of times of circulating on the first closed trajectory.

12. The laser processing method according to claim 1, wherein
a scan speed of the first closed trajectory and a scan speed of the second closed trajectory are equal.

13. A laser processing apparatus comprising
a light condensing lens configured to condense a pulse laser beam having an ultraviolet wavelength onto fluororesin that is a workpiece;
a moving device configured to move an irradiation position of the pulse laser beam on the fluororesin; and
a processor configured to control the moving device,
the processor executing
first control for processing a pilot hole by irradiating the fluororesin with the pulse laser beam so as to draw a first closed trajectory, and
second control for processing a hole by irradiating the fluororesin in which the pilot hole is processed with the pulse laser beam so as to draw a second closed trajectory that is similar in shape to the first closed trajectory and is larger than the first closed trajectory.

14. The laser processing apparatus according to claim 13, further comprising
a dust collecting mechanism configured to protect the light condensing lens.

15. The laser processing apparatus according to claim 14, wherein
the dust collecting mechanism includes a dust collecting head configured to generate a spiral airflow and a dust collector connected to the dust collecting head.

16. The laser processing apparatus according to claim 13, further comprising
a purging mechanism configured to make an inert gas flow into an optical propagation part including an optical system that guides the pulse laser beam to the light condensing lens.

17. The laser processing apparatus according to claim 13, wherein
the processor
controls the moving device so as to draw the second closed trajectory on an inner side of an area where a thickness of the fluororesin is changed due to the first control.

18. The laser processing apparatus according to claim 13, wherein
the ultraviolet wavelength is between 158 nm and 246 nm.

19. The laser processing apparatus according to claim 13, wherein
the pilot hole is a through-hole.

20. The laser processing apparatus according to claim 13, wherein
the first closed trajectory and the second closed trajectory are concentric circles.
